(19) United States
(12) Patent Application Publication
(10) Pub. No.: US 2004/0133629 A1
(43) Pub. Date: Jul. 8, 2004

(54) Methods, systems and devices for automated web publishing and distribution

(76) Inventors: Brian Reynolds, Hopewell (JM); Frank Stewart Barr, Smyrna, GA (US)

Correspondence Address: David Jacobs, Lucash Gesmer & Updegrove, 40 Broad Street, Boston, MA, 02109, US

(21) Appl. No.: 10/470,880

(22) PCT Filed: Feb. 1, 2002
(86) PCT No.: PCT/US02/02841

(51) Int. Cl. G06F 15/16; G06F 15/173

(52) U.S. Cl. 709/202; 709/224; 709/236

(57) ABSTRACT

PC ROBOT methods, systems and devices are disclosed, one embodiment (MySharer) of which provides automated web publishing functions. One aspect includes the steps of designating, on a local processing system, at least one file or directory containing at least one file for copying to a remote server via a network; detecting whether changes have been written to the designated files or directories; and if changes have been written to the designated files or directories, copying, to a remote processor, via the network, information representative of the at least one changed file or the changes thereto. The invention provides users of the world wide web with tools to publish, distribute, archive from server to server or within a single processor and be connected with a group of users with similar shareable work, such that every user will have the capability to access the most current version of a data object in the form of digital data or multimedia, which may include a data file, or a directory, thereby providing PC to Web Publishing or Caching using an IBOOK server, or an FTP server.

### CROSS REFERENCE TO RELATED APPLICATIONS

This application claims priority from its related provisional application S/N 60/265,958 titled “PC ROBOT”, filed on Feb. 2, 2001. This application also incorporates by reference published U.S. Pat. No. 6,052,717, issued Apr. 18, 2000, commonly and jointly owned, titled “Interactive Web Book System” with S/N 08/735, 727 filed on Oct. 23, 1996.

### FIELD OF THE INVENTION

The present invention relates to the Internet and World Wide Web in general, and, in particular, relates to methods and systems for automatically detecting specified conditions on a processor, and then executing a series of commands, such as a script, in response thereto, without requiring further input by a human user, and optionally publishing or distributing such information or content, either on demand or automatically. An example of such information would be a data file, containing audio, video, text, available in any format, or a directory, or both, hereinafter called a data object.

### BACKGROUND OF THE INVENTION

With the growth of the Internet and networked personal computing, it has become increasingly useful for groups of users to collaborate on projects or otherwise seek access to distributed information. In this regard, it would be useful, in order to facilitate collaboration among and between users, to enable node-to-node synchronization and/or distribution of content. More generally, it would be useful to support an autonomous agent with a user interface (i.e., a PC “robot”), to enable a personal computer (PC) to detect certain predetermined or subsequently modified conditions on the PC, and in response to such detection, to execute a predetermined command sequence, such as a script. One example of such a script would enable the distribution and/or synchronization of content between and among processors, whether between PCs, servers, or otherwise.

A number of protocols exist for copying files from local processing systems, such as conventional personal computers (PCs) to a remote processing system. By way of example, Netscape's U.S. Pat. No. 6,148,330 discloses a system and method for automatically generating content for distribution via a network channel. The system includes a channel service provider that has a first automatic data processing system, which includes a data storage sub-system for storing a network document and a first processor that is operative to specify a section of the network document to be broadcast via the network channel and to automatically scan the network document to extract and store the section of the network document in a network addressable resource within the data storage sub-system. The system also includes a second automatic data processing system, coupled to the channel service provider, including a content manifestation device and a second processor that is operative to access the network addressable resource to retrieve the section of the network document and to cause the content manifestation device to manifest the section of the network document.

As a further example, AOL's U.S. Pat. No. 5,870,552 discloses a client-server development platform for handling functions of document authoring, content-based indexing and retrieval of documents, management and control of proprietary assets, and support for developing form-driven interactive services.

U.S. Pat. No. 5,727,156 to HotOffice discloses a method for posting hypertext documents to a hypertext server so as to make the hypertext documents accessible to users of the hypertext document system while securing against unauthorized modification of the posted hypertext documents. The hypertext documents form a portion of the World Wide Web. A process for posting hypertext documents begins with an author authoring the hypertext pages on a client computer, sending an add request to a server computer, causing the generation of a unique identifier for the author of the hypertext document, obtaining a charge authorization from the author, and sending a database entry request from the client to the server comprising the unique identifier, the charge authorization and the hypertext files comprising the document. At the server, the validity of the charge authorization is verified, and if the charge authorization is valid, the hypertext pages are stored in association with the unique identifier and the client is provided with a password needed to effect future modifications of the hypertext pages so published.

In addition, U.S. Pat. No. 5,710,883 to Lumen Intellectual Property Services discloses a method for publishing a hypertext file set on a world-wide web server machine by packaging the hypertext file set as an e-mail message on a client machine, transporting the e-mail message over the internet from the client machine to the world-wide web server machine, unpacking the e-mail message to recover the hypertext file set, and depositing the hypertext file set into a memory means on the world-wide web server machine. By using the e-mail transport mechanism, a direct internet connection between the client and server is not necessary. Consequently, the method allows files to pass through security firewalls and allows geographically disperse individuals to remotely update information at a WWW site without compromising server security. The patentee asserts that processing time direct connections sharing the server's resources and internet bandwidth is not wasted. The method uses standard internet protocols and generic server software, therefore freeing the world wide web server from the clutter of client-specific software to handle special protocols and data structures.

In addition, a product known as DropChute, sold by Hilgraeve Inc. of Monroe, Mich., and the well-known Napster file-sharing system, utilizes protocols for file copying and sharing from PCs to a remote processor.

However, conventional protocols such as those disclosed in the above-referenced patents or products do not provide automatic copying of files or information, of whatever kind (whether text, database, video, sound, or other) to a Web server, without further input by a human user, and with transparent, seamless operation with existing applications programs such as Microsoft Word, Explorer, Office, Media Player, and the like. Accordingly, there exists a need for methods, systems and devices that provide such functionality.

### OBJECTS OF THE INVENTION

It is thus an object of the invention to enable a personal computer (PC) to support an autonomous agent thereon with a user interface to direct it (i.e., a “PC robot”) capable of detecting certain predetermined or spontaneous conditions on the PC and in response to such detection, to execute a predetermined command sequence, such as a script, or according to the spontaneous conditions. One example of such a script would enable the distribution and/or synchronization of content between and among processors, whether between PCs, servers, or otherwise.

It is thus another object of the present invention to provide methods, systems and devices that enable copying of files, information, or content of whatever kind (whether text, video, sound, program code, or other) to a Web server, without further input by a human user, and optionally distributing such files, information, or content, either on demand or automatically.

It is a further object of the invention to provide methods, systems and devices that are easily configured and employed by individual users, enterprises and web hosting services.

It is another object of the invention to provide such methods, systems and devices that will operate transparently and seamlessly with existing applications programs commonly used in contemporary operating systems, such as Microsoft Word, Explorer, Office, Media Player, and the like.

It is a further object of the invention to provide such systems that allow users to employ their exiting software applications, in the manner they have always used such applications, but with the added functionality of automatic copying and/or distribution.

It is still another object of the invention to provide such methods, systems and devices that permit users to seamlessly share music, text, pictures, faxes, email, phone calls, video, programs, animation and other content among a group or community, or with the public.

It is yet another object of the invention to provide such systems in which, in one embodiment, such files, information or content are automatically published to a web server from which other users can access the shared material from any computer or processing device, using only a browser and communications channel.

In another embodiment, files, information or content, whether on a PC, server or the equivalent, can be automatically distributed to other users, or sent by email or telephone, fax or other means of communication.

It is yet another object of the invention optionally to automatically generate or support, where requested, a virtual private network (VPN), or an equivalent thereof, to permit the transfers specified by the MySharer parameters as described herein.

It is another object of the invention to generate or support access to proprietary operating systems and environments such as Multiple Virtual Systems (MVS) or the like, in which a directory would be mapped onto a partitioned data set.

It is a further object of the invention to enable or facilitate “mirroring” or replication of content between servers, for example by an equivalent “server robot” and/or PCs or other processing devices.

### SUMMARY OF TH INVENTION

These and other objects are obtained in accordance with the principles of the present invention by providing a method and system, one implementation of which, hereinafter referred to as the “MySharer” for automatically copying and/or publishing designated files from one or more local processors to one or more remote processors connectable to the local processors via a network, and, in certain embodiments of the invention, in which the files are then distributed to other users, either automatically or on demand.

In accordance with one aspect of the invention there is provided a method of automated Web publishing including the steps of designating, on a local processing system, at least one file or directory containing at least one file for copying to a remote server via a network; detecting whether changes have been written to the designated files or directories; and if changes have been written to the designated files or directories, copying, to a remote processor, via the network, information representative of the at least one changed file or the changes thereto; and, if so specified, new files that have arisen on designated directories.

The local processor can be a conventional PC operating in conjunction with a conventional operating system, such as Microsoft Windows or Microsoft NT, Apple Macintosh, LINUX, UNIX or the like.

The remote processor or processors can be another PC, a server, or the like, also operating in conjunction with a conventional operating system such as Microsoft Windows or Microsoft NT, Apple Macintosh, LINUX, UNIX or the like.

The operating system of the remote processor need not be the same as the operating system of the local processor. The network by which the remote and local processors can be connected can be a local area network (LAN), wide area network (WAN), an intranet, an extranet, the Internet, the World Wide Web or the like.

The method and system also provides automatic copying to a web server of designated files, or files on a designated directory on a local processor, wherein such files are of a type normally used by existing applications software. Users can then browse such files, information or other content using conventional Web browsers. Methods and systems are also provided for distributing the copied information or files, automatically or on demand, to other users of the network.

In another aspect of the invention, the MySharer system can work in a single processor mode for automated storage of multiple revisions or versions of a file, wherein information representative of at least one changed file or the changes thereto may be published or archived to itself, but capable of later being in communicating relationship with another processor/s to publish or replicate updates on one or more remote processors. In this embodiment the system, as an example, can retain all revisions and file changes, copying each new revision or version with a new file name, incorporating author, date and time information into the same or different directory on itself. Such multiple revisions could be copied by MySharer for other purposes such as automated web publishing, or archiving, or distribution, or file caching. One implementation could be maintained in an I-book environment.

In accordance with a further aspect of the invention, the methods, systems and devices disclosed herein can be practiced in conjunction with the Ibook methods, systems and devices disclosed in commonly-owned U.S. Pat. No. 6,052,717, entitled Interactive Web Book System, the disclosure of which is incorporated in its entirety herein by reference, and a copy of which forms Appendix A hereto.

The invention thus allows users to, among other things, seamlessly share music, text, pictures, faxes, email, phone calls, video, animation and other content among a group or community, or with the public, and to access the shared material from any computer, using only a browser and a communications channel.

Further features of the invention, its nature and various advantages are shown and described in the accompanying drawings and written description.

This specification and attached drawing figures present the invention at various levels of enabling detail, from conceptual to specific examples of implementation. It will be appreciated by those skilled in the art that the present invention may be practiced in connection with details that differ from the specific examples of implementation set forth herein. By way of example, those skilled in the art will appreciate that the methods, systems and devices described herein can be implemented in devices, systems and software other than those depicted or described herein, and that the examples set forth herein are provided by way of illustration rather than limitation. In other instances, conventional or otherwise well-known structures and devices are described by way of reference to known or conventional software or hardware engineering terminology.

### BRIEF DESCRIPTION OF THE DRAWINGS

FIG. 1 is a flowchart depicting the various modes of using the invention.

FIG. 1a depicts the flow of the Web Publishing embodiment.

FIG. 1b depicts the Web Caching and Distribution embodiment

FIG. 1c denotes the flow of the Replication embodiment.

FIG. 2 is a flowchart showing how to construct MySharer as an automated Web Publisher.

FIG. 3 is a flowchart showing MySharer's added ability to cache new or changed files on the Web server to the client.

FIG. 4 is a flowchart depicting the Automated Publishing algorithm of the system and method.

FIG. 5 is a flowchart depicting the synchronization of files between server and client when there is a new file published.

FIG. 6 is a flowchart describing the Push Algorithm running in a first processor.

FIG. 7 is a flowchart describing the Pull algorithm running in a first processor.

FIG. 8a is a flowchart describing the Push-Pull Algorithm running in a first processor.

FIG. 8b is a flowchart describing a Directory Compare Routine of a first variant running on a first processor.

FIG. 8c is a flowchart describing a Directory Compare Routine of a Second Variant running on a first processor.

FIG. 9 is a flowchart describing PC to Web Publishing using the IBOOK server as a preferred embodiment.

FIG. 10 is a flowchart describing PC to Web Publishing using a widely available FTP server.

FIG. 11 is a flowchart describing PC to Web Publishing and Caching, single user at a time, using IBOOK implementation.

FIGS. 12a through 12h are “screen shots” of steps 1 through 7 depicting displays created by the system and method of the invention.

### DETAILED DESCRIPTION OF THE INVENTION

General Overview

The invention is useful for users using the World Wide Web who are familiar with using browsers, and have share-able work experiences, that may include music, or text. These users may not have the expertise or inclination to learn how to publish on the web. The method and system “MySharer” can be used with the existing PC, and the existing software to create, and share work file between and among users. The creating of new work or derivations of old work, hereinafter denoted as “publishing” uses the “push” algorithms detailed later. The invention is also designed to be used in a “share or replicate” mode, hereinafter referred to as “cache”, wherein, instead of publishing, the system will cache any updated or new files on the remote processor (web server) onto a user's local processor. This enables users to also have an up to date set of files to work with, if on the road, with a laptop, and promotes collaborative effort between a predesignated, preauthorized group of users, at the same time providing current updates of data changes to each of the machines. For example, if a user has a PC in her London Office, a second PC in her New York Office. While working on her PC in London, the invention transfers file updates to a web server. At the same time, the PC in New York is caching these files. Therefore when the user visits the New York Office, the PC in that office will have up-to-date files.

In the discussion set forth hereinafter, for purposes of explanation, specific details are set forth in order to provide a thorough understanding of the invention. It will be appreciated by those skilled in the art that the present invention may be practiced without these specific details. In particular, those skilled in the art will appreciate that the methods described herein can be implemented in devices, systems and software other than Microsoft Windows-based PC or server platforms connected via the Internet, and the examples set forth herein are provided by way of illustration rather than limitation. In other instances, conventional or otherwise well-known structures and devices are referred to by way of conventionally known terminology in order to facilitate description of the present invention.

The present invention includes steps that may be embodied in machine-executable software instructions, and thus the present invention includes a method that is carried out in a processing system as a result of a processor executing the instructions. In other embodiments, hardware elements may be employed in place of, or in combination with, software instructions to implement the present invention.

In one embodiment, the present invention is included in a system in which a local processor, such as a conventional PC operating in accordance with Microsoft Windows or Microsoft NT, contains standard software and hardware for connecting to the Internet or World Wide Web, using a standard telephone modem apparatus, cable modem, or other similar communication path. A user of such a PC system can access, via the Internet, digital data, content and services provided by one or more remote servers, in accordance with known Internet practice, enabling the user to browse the Web, send electronic mail, and otherwise employ the Internet.

In addition, the user of the referenced conventional PC system can utilize various standard applications programs, such as Microsoft Word, Internet Explorer, Media Player and the like, to generate, obtain and manipulate digital information, which is typically written and stored in the form of digital files. The files, which can be stored on magnetic disks or other conventional storage media, can be organized in directories in accordance with conventional practice.

In this environment, or an environment similar thereto, the present invention provides methods, systems and devices for enabling the automatic copying and/or publishing of files to a remote processor or server, such as a server connectable to the local PC via the Internet. As depicted in the attached drawings, the method includes the steps of designating, on the local processing system (for example, the local PC), at least one file or directory containing at least one file for copying to a remote server via a network; detecting whether changes have been written to the designated files or directories; and if changes have been written to the designated files or directories, copying, to a remote processor, via the network, information representative of the at least one changed file or the changes thereto.

PC Robot Overview

These and other objects are attained in accordance with the principles of the present invention by providing methods, systems and devices to enable a personal computer (PC) to support an autonomous agent with a user interface thereon (i.e., a “PC robot”) capable of detecting certain predetermined conditions on the PC and in response to such detection, to execute a predetermined or subsequently modified command sequence, such as a script. One example of such a script would enable the distribution and/or synchronization of content between and among processors, whether between PCs, servers, or otherwise.

In the most general aspect of the invention, PC robot methods and/or devices are provided to execute the following algorithm:

Whenever Event, Do Script.

This permits the PC robot to perform any set of tasks specified by the Script (i.e., command sequence), when an Event (which may be any expression involving events, times or conditions) is detected.

An example of an event is a new or updated file. Accordingly, in the MySharer aspect of the invention, the PC robot executes the following algorithm:

Whenever New or Updated File, Do Script.

This permits the PC robot to perform any set of tasks when a new or updated file is detected. Further, a selected event may be triggered by any of a particular time or times, a last change, whenever a new file is detected, whenever an object is updated, or whenever a directory is changed.

MySharer System Overview

In the embodiment describing a system, hereinafter defined as “MySharer”, the invention provides methods, systems and devices for automatically copying and/or publishing designated files from one or more local processors to one or more remote processors connectable to the local processors via a network, and, in certain embodiments of the invention, in which the files are then distributed to other users, either automatically or on demand.

In accordance with this aspect of the invention there is provided a method of automated Web publishing, including the steps of designating, on a local processing system, at least one file or directory containing at least one file for copying to a remote server via a network; detecting whether changes have been written to the designated files or directories; and if changes have been written to the designated files or directories, copying, to a remote processor, via the network, information representative of the at least one changed file or the changes thereto; and, if so specified, new files that have arisen on designated directories.

The local processor can be a conventional PC operating in conjunction with a conventional operating system, such as Microsoft Windows or Microsoft NT, Apple Macintosh, LINUX, UNIX or the like.

The remote processor or processors can be another PC, a server, or the like, also operating in conjunction with a conventional operating system such as Microsoft Windows or Microsoft NT, Apple Macintosh, LINUX, UNIX or the like.

The operating system of the remote processor need not be the same as the operating system of the local processor.

The network by which the remote and local processors can be connected can be a local area network (LAN), wide area network (WAN), an intranet, an extranet, the Internet, the World Wide Web or the like.

In one embodiment of the PC robot invention, methods and systems are provided for automatic copying to, and listing on, a web server of designated files, or files on a designated directory on a local processor, wherein such files are of a type normally used by existing applications software. Users can then browse such files, information or other content using conventional Web browsers.

In another embodiment of the robot invention, methods and systems are provided for distributing the copied information or files, automatically or on demand, to other users of the network.

In accordance with a further aspect of the invention, the methods, systems and devices disclosed herein can be practiced in conjunction with the Ibook methods, systems and devices disclosed in commonly-owned U.S. Pat. No. 6,052,717, entitled Interactive Web Book System, the disclosure of which is incorporated in its entirety herein by reference, and a copy of which forms Appendix A hereto. In particular, MySharer can create server files in the Ibook format, i.e., create Ibooks of them. In addition, MySharer, suitably scripted, can support or function as the automated cache memories of Ibook clients and servers.

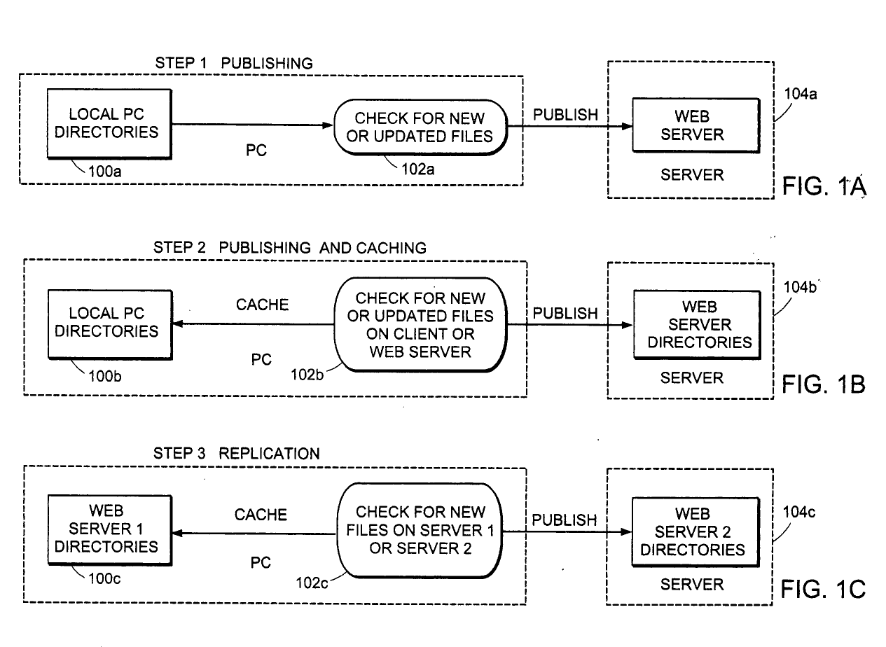

Theoretical Aspects and Overall Logic of the Invention (FIGS. 1 to 5)

Referring to the attached drawings:

FIG. 1 is a broad overview of the “MySharer” invention. FIGS. 1a, 1b and 1c depict three practices of the automated publishing aspects of the PC Robot invention, referred to, respectively, as “Step 1—Publishing”; “Step 2—Publishing and Caching”; and “Step 3— Replication”.

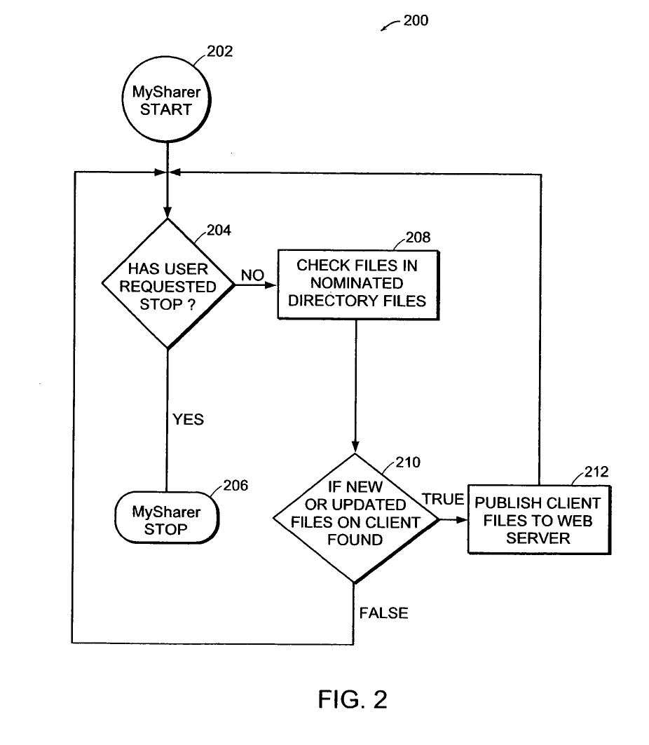

In Step 1, FIG. 1a, there is depicted a set of local PC directories as shown at 100a, the step of checking for new or updated files as shown at 102a, and the step of publishing by “pushing” to a Web Server as shown at 104a. The dashed box at step 100a denotes a local PC. These steps can be accomplished by executing the detailed steps depicted in the following flowcharts FIGS. 2, 3, and 4. It will be understood that multiple users and PCs can be connected to or access the Web Server. The invention also includes for a single processor system wherein the MySharer archives a new or updated copy to be later used for distribution and replication.

In Step 2, FIG. 1b, there is depicted another practice of the invention: the step of caching by “pulling” from a Web Server, combined with the step of publishing to a Web Server (as depicted in Step 1). This Step 2 is entitled “Check for New or Updated Files On Client or Web Server”. The dashed box at step 100b denotes a local PC.

In Step 3, FIG. 1c, there is a similar practice to Step 2 but employed between servers to create “mirrored” or replicated servers. This Step 3 is entitled “Replication”. The dashed box at step 100c denotes a Web Server1 Directories.

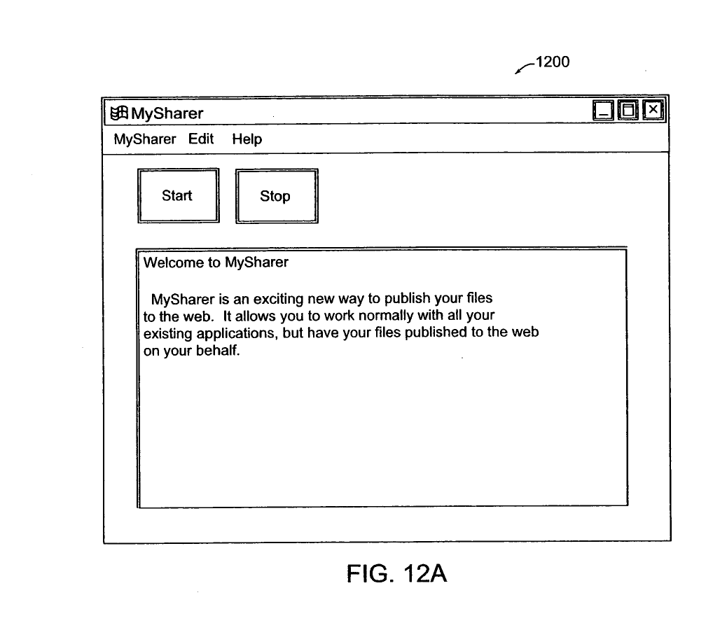

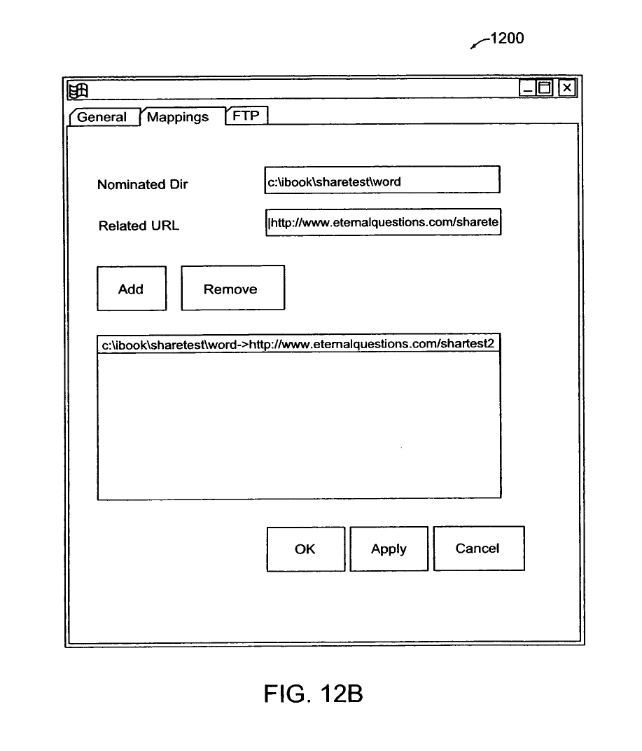

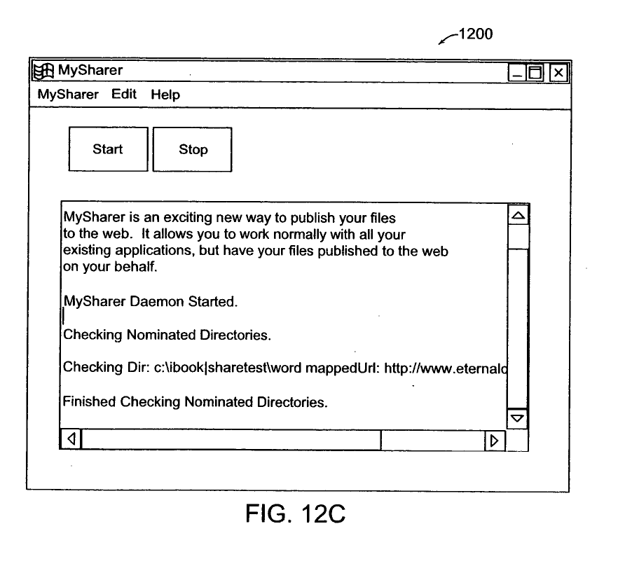

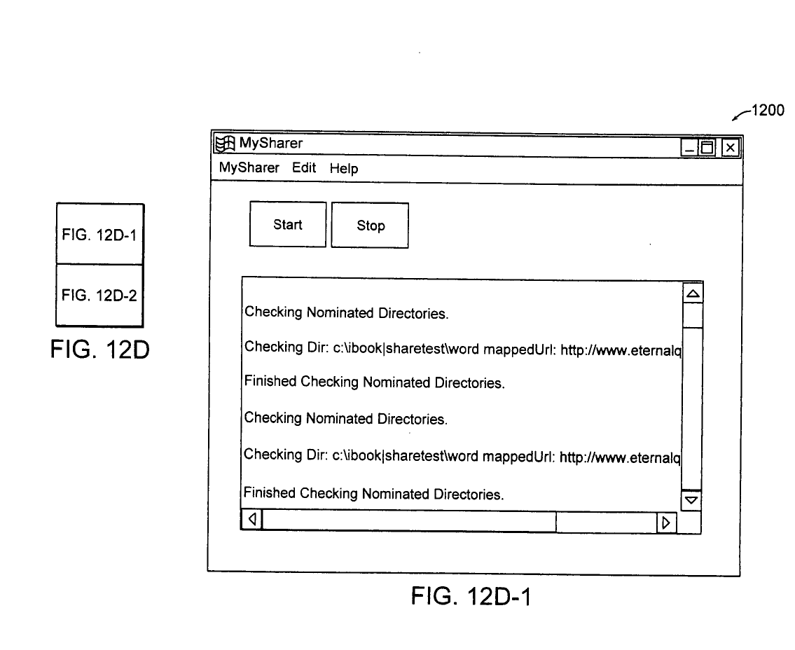

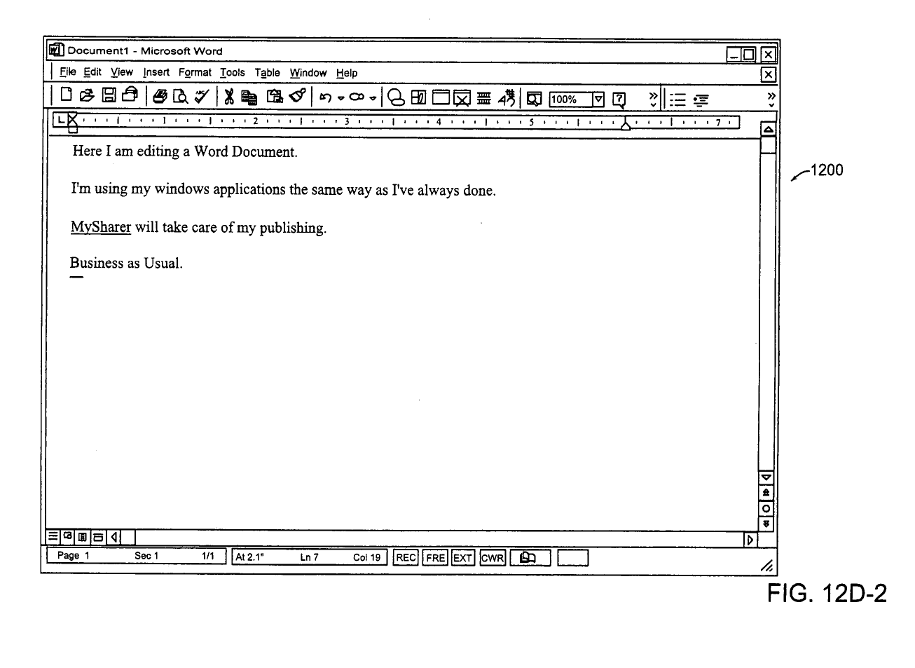

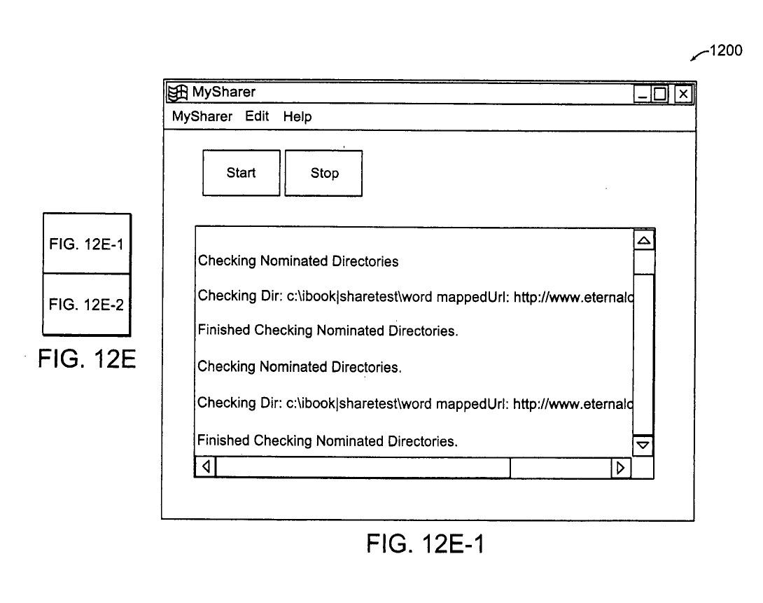

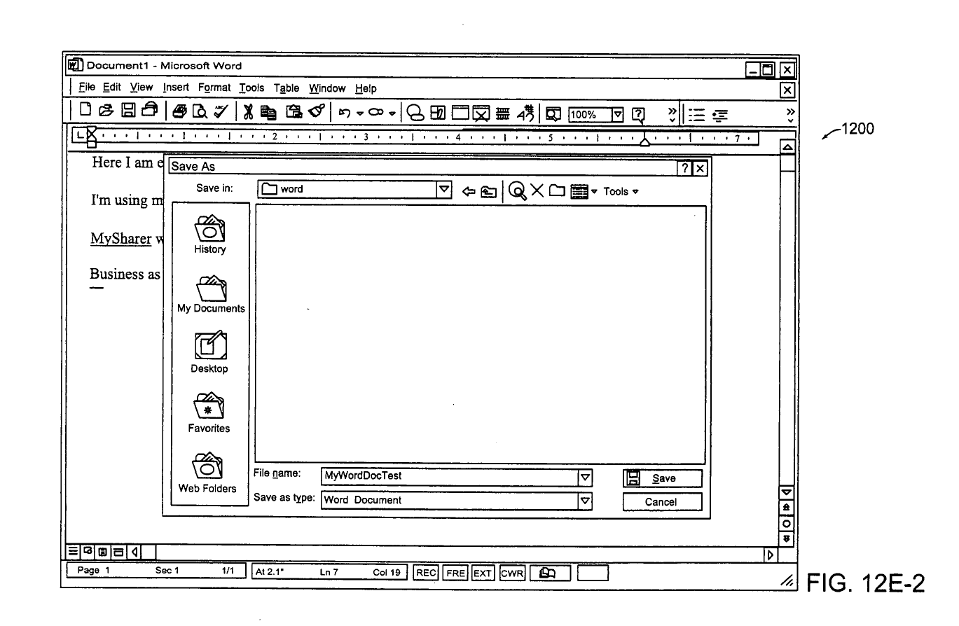

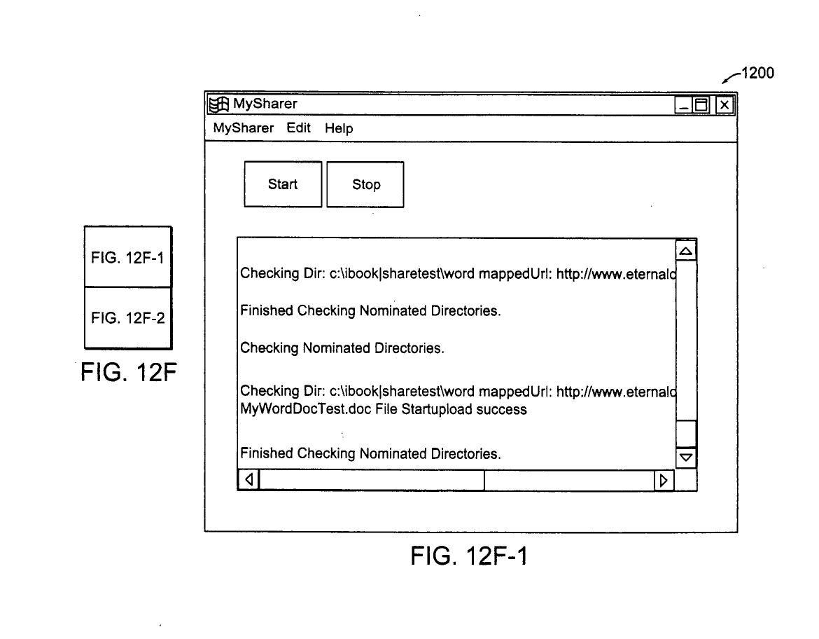

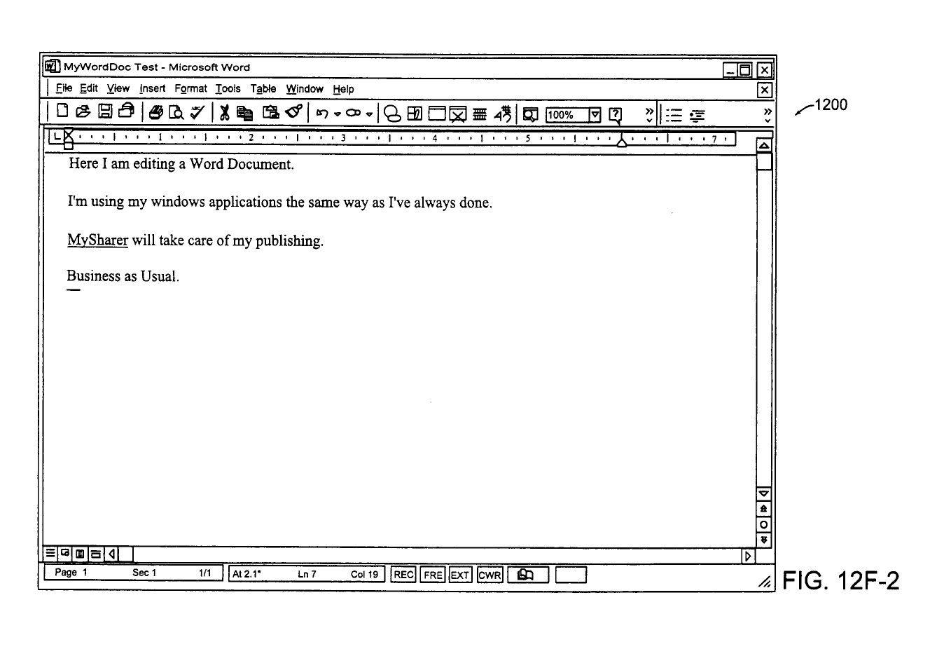

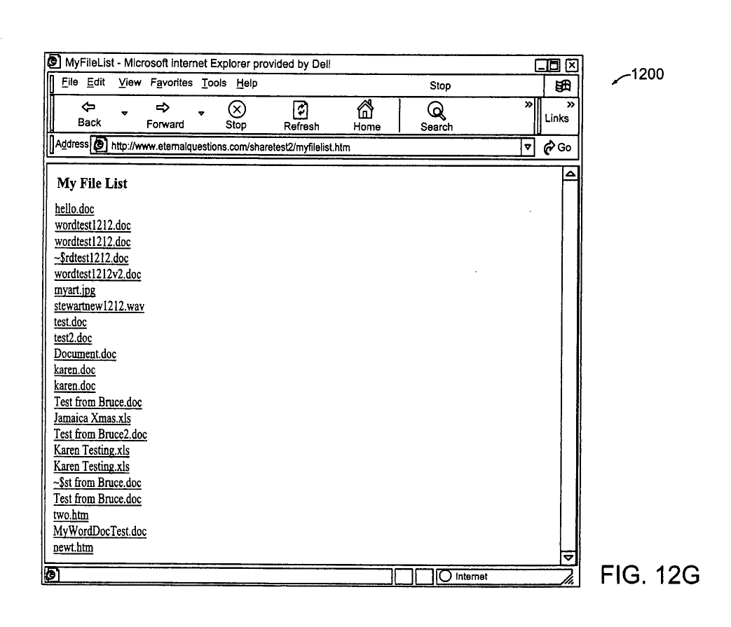

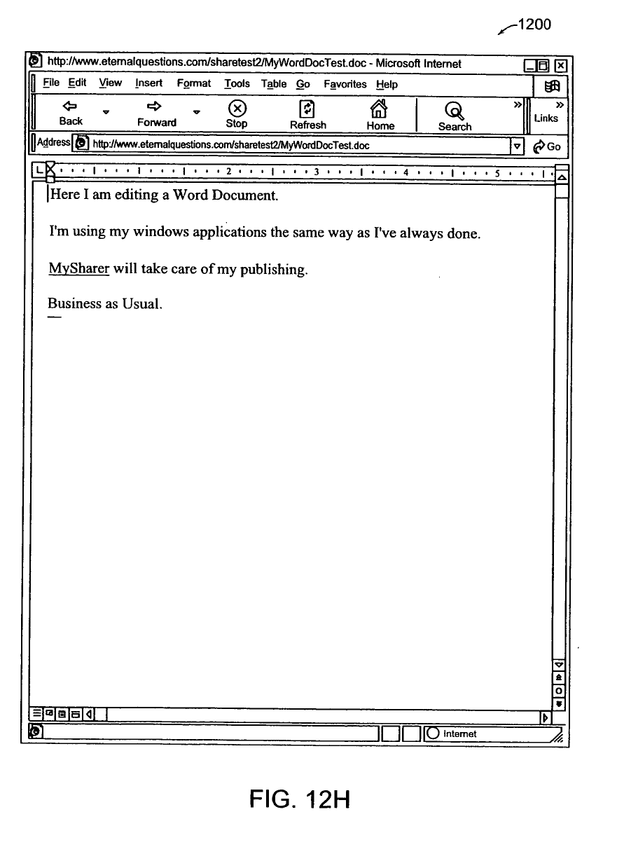

FIG. 2 is a flowchart depicting an embodiment of the system and method of the invention (which is referred to herein as “MySharer”), which embodiment functions as an automated web publisher. FIG. 2 thus depicts how to construct the MySharer system as an automated web publisher. The daemon depicted here is an autonomous agent responsible for detecting certain conditions, and further executing a predetermined command sequence. Together with the user interface to control it (FIG. 12) and modify its command sequence, these constitute MySharer as a PC Robot.

1. MySharer Start;

2. Has user requested stop?.

3. then Check files in nominated directory files against web server directory files;

4a. If new or updated files on client are detected, then publish client files to web server;

4b. If new files are not detected, then return to Has user requested Stop?; and

5. (as requested by user or system) MySharer Stop.

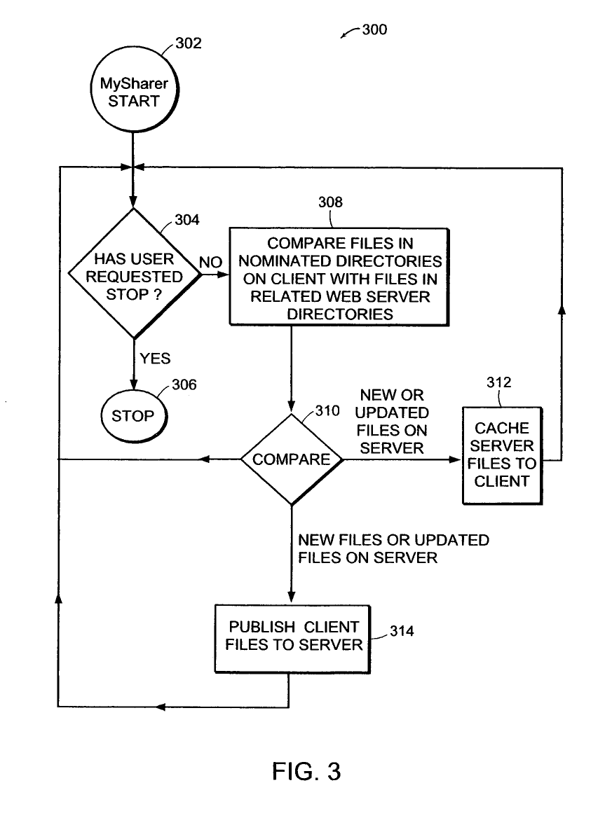

FIG. 3 is a flowchart depicting another embodiment of the system and method of the invention which includes the added ability to cache new or changed files on the web server to the client.

1. MySharer Start;

2. If Has user requested stop . . .

3. Compare files in nominated directories on client with files in related (i.e., corresponding) web server directories;

4. If New or Updated files on the server are detected.

5. then cache server files to client and return to Has user requested stop? step;

6. If new or updated files on the Client are detected then

7. Publish client files to server and return to Has user Requested stop? step.

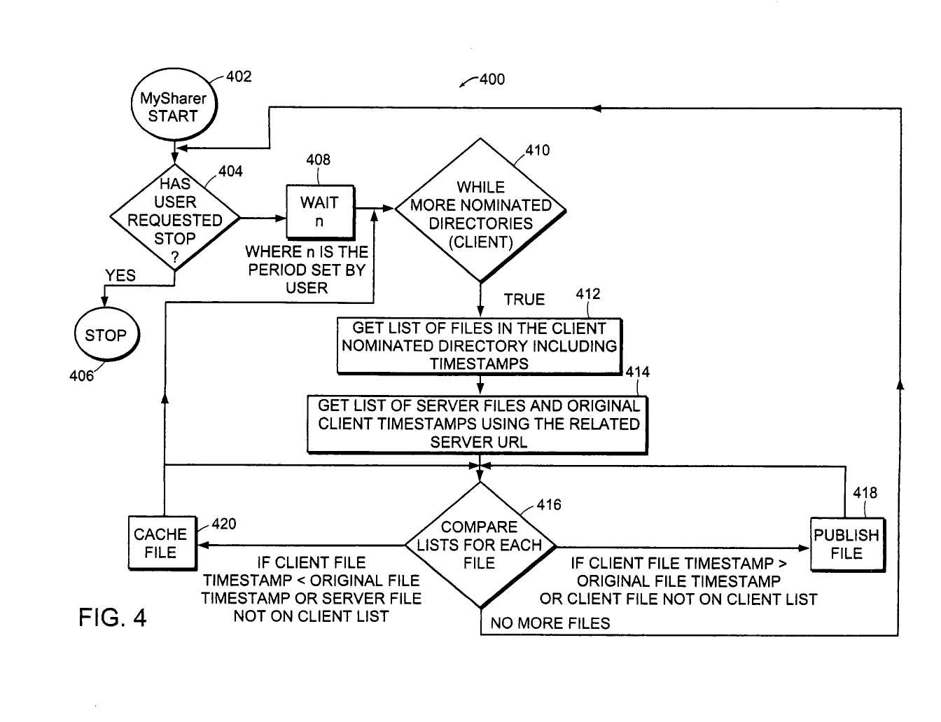

FIG. 4 is a flowchart depicting another embodiment of the “MySharer” system and method of the invention, including a comprehensive Push-Pull automated publishing algorithm, including the following steps:

1. MySharer Start,

2. Has User requested stop . . .

3. If True (has user requested stop), then Wait n (where n is a settable delay period);

4. Check for More Nominated Directories (on the Client side);

5. If there are More Nominated Directories, then . . .

6. Get List of Files in Client Nominated Directory(ies), including timestamps;

7. Get List of Server Files and Timestamps using the related (i.e., corresponding) Server URL;

8. Compare Lists (i.e., Client-file-in-Nominated-Directory(ies) list and Server File List) (and associated timestamps);

9. If, for a given file, Client Timestamp is Greater Than (>) Server Timestamp (i.e., client version is more recent than server version) or Client File Not On Server List, then . . .

10. Publish (i.e., copy) File and

11. Return to Check for More Nominated Directories step;

12. If, for a given file, Client Timestamp is Less Than (<) Server Timestamp (i.e., client version older than server version), or Server File Not on Client List, then . . .

13. Cache File and return to Check for More Nominated Directories step.

In this regard, referring back to FIGS. 1a, 1b and 1c, in accordance with another aspect of this invention, the MySharer embodiment of the PC robot system can either “push” or “pull” files (as described in greater detail below), depending upon user-controlled settings, which may be, for example, whether the user has set a “file caching” option.

The “push” operation (see FIG. 1a) is associated with the MySharer web publishing activities. The “pull” operation is associated with the MySharer caching activities.

In another mode of operation (referred to herein (also see FIG. 1b) as Step 2 of the “MySharer” push-pull algorithm described below), there is permitted both the publishing and caching of files, between a client and a server or other PC. Naturally, the same result could be accomplished by having two instances of “MySharer”, one on each local PC, server or other processor. Each “MySharer” in that case would “push” information to the other machine. Such processors could also “pull” material from each other. This would also hold true for server-to-server publishing or caching.

Peer-to-Peer Distribution Agent

The MySharer embodiments, while intended for web publishing, also can function as a peer-to-peer distribution agent, enabling users to publish their local files to each other's PCs, telephones, faxes, pagers, televisions or the like. Similarly, the aspects disclosed herein enable MySharer to distribute files on web servers to other web servers, or create replicated or “mirrored” servers (as in FIG. 1c, Step 3).

FIG. 4 includes the following steps: Upon start and If User has requested a Stop, Daemon running, the system is prompted to wait n, where n is a settable delay period. Other nominated directories are checked on the client side, and if there are more nominated directories, then the list of files in the client nominated directories, including the associated timestamps are obtained. Then, a list of server files and timestamps using the corresponding server URL are obtained. A compare function is executed wherein the lists are compared, i.e., client-file-in-nominated-directory(ies) list and server file list along with their associated timestamps. If for a given file, the client timestamp is greater than a server timestamp, (i.e., client version is more recent than server version) or client file not on server list, then the file is published (or copied) and the system returns to check for more nominated directories step. If, on the other hand, for a given file, the client timestamp is less than the server timestamp (i.e., client version older than server version), or server file not on client list, then, the file is cached and the system returns to check for more nominated directories step. If, for a given file, the compare list gives an equal condition, (i.e., client version equal to the server), then the system prompts to start right after the initial start step and wait for yet another interval of time.

The present invention thus provides methods, systems and devices for autonomous web publishing that operates in conjunction with existing applications programs such as Microsoft Word, Internet Explorer, Media Player and the like. The system is transparent to the user, such that the user need not even know that the system is operating. In addition, the user need not possess specialized knowledge of techniques of web publishing. The system could be set to monitor designated target directories, and could map from local directory into a remote Web server directory. In another embodiment of the invention, the system could map into an ibook directory. (The ibook system is described in detail in Appendix A attached hereto.)

File Synchronization

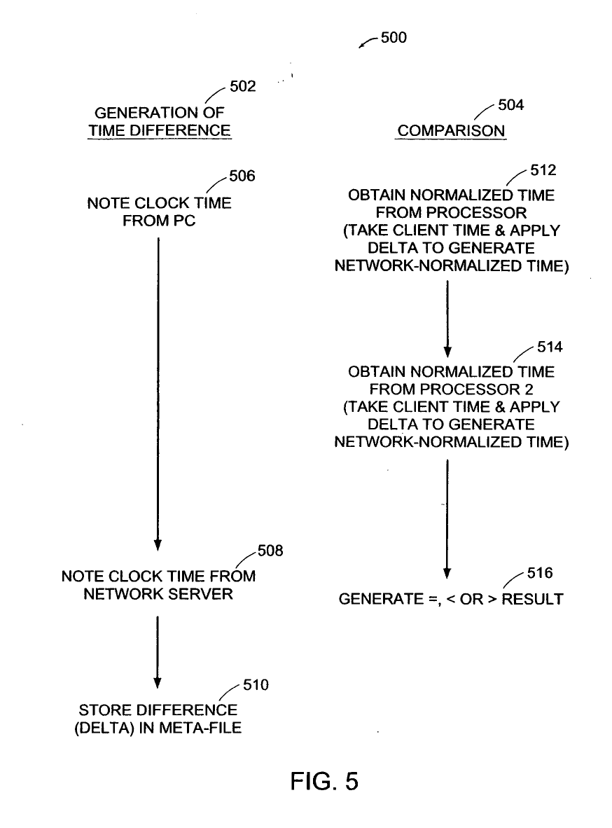

FIG. 5 shows another aspect of the invention, wherein a method is described for solving file synchronization issues. It is understood that for several reasons, it is likely that the time of a file on the server may not be the same as the equivalent file on the client, after the client file has been published. This may result, for example, from time delay on the file being sent, and/or from the server's internal time-clock being out of synchronization with time on the client. Thus, in another aspect of the invention, the following method, of using the client time stamps is used to solve this problem:

FIG. 5 is a flowchart depicting a further aspect of the invention, i.e., a method of timestamp normalization. Timestamp normalization is useful because, for example, a server's internal time clock may be out of synchronization with time on the client. The invention addresses this issue by generating normalized times based on time differences, and using the normalized times to compare file or data object timestamps, as follows.

As shown in FIG. 5, the method can be divided into two components, referred to as generation of time difference (502) and comparison (504). These processes may be asynchronous with respect to each other, as described below. The generation of time difference process begins with obtaining a clock time from the PC or other processor (506). Next, a clock time is obtained from the network server or other processor (508). A difference (or delta) between these two clock times is calculated and stored in a meta-file (510) for later reference.

The comparison process (504), which can be executed as soon as possible after creation or modification of a file or other data object, begins with obtaining a normalized time from processor 1 (step 512), which is calculated by taking the client time and applying the stored delta value, to generate a network-normalized time. Next, a normalized time is obtained from processor 2 (step 514), in a similar manner (by taking the client time and applying the stored delta value to generate a network-normalized time. Finally, by comparing the normalized time from processor 1 and the normalized time from processor 2, a result of “equal”, “less than” or “greater than” is generated, thereby indicating which timestamp is more recent.

The normalized timestamps are thus generated by taking a client time from each processor and applying a delta or difference value to generate a network-normalized time. The method then compares normalized times on both client and server. As a result, any differences in clock values on the client or server are taken into account.

This approach solves problems caused by the fact that the client time might not always be correct or the same. For example, once a file is written, and subsequently the clock time changes (or increments incorrectly) on the client (perhaps due to power outages), the client time reading would be false. Therefore, normalized network times are generated by taking the client times and applying the (presumably invariant) delta values, representing the difference between the client and server times (or 1^{st} and 2^{nd} processor times) to generate a network normalized time. Information pertaining to both the name of a given file and the difference between PC time and network time can be stored in an associated meta-file (such as filename_itag.htm).

This normalization technique provides an easy-to-implement algorithm for obtaining a reference time, and can be used to normalize server times, or to normalize times both on multiple clients and servers. The push, pull, and push-pull algorithms described elsewhere in the document may advantageously employ this normalization technique. The technique is operable in a multi-PC environment, and can even operate with a server that has an incorrect time, so long as the server clock is not reset, and continues to increment in a normal manner. A further implementation of the technique can utilize a “time-server”, such as a network time server, GPS receiver, or atomic clock receiver.

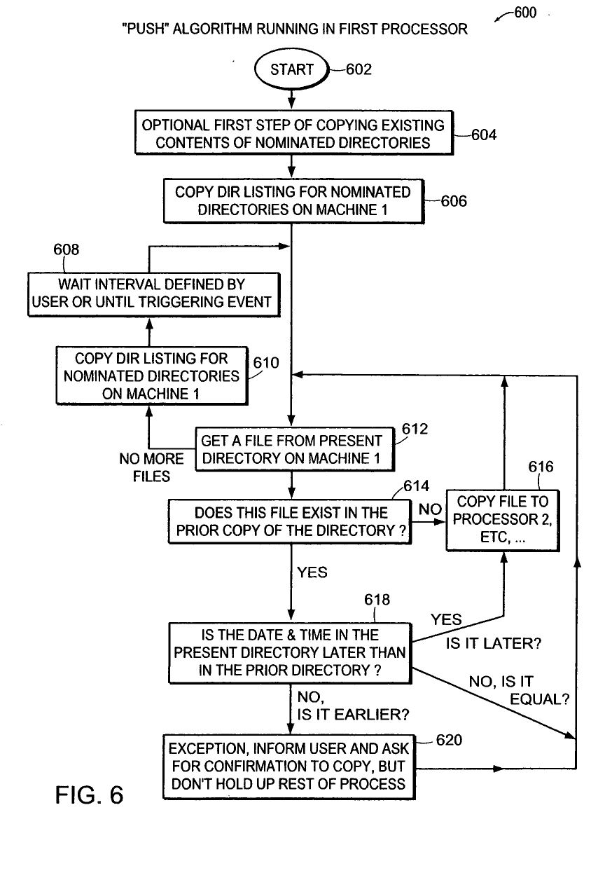

Detecting New or Changed Data Objects (FIGS. 6,7,8a,b,c)

Overview

In accordance with another aspect of the invention, the MySharer embodiment of the PC robot can either “push” or “pull” files (as described in greater detail below), depending upon user-controlled settings, which may be, for example, whether the user has set a “file caching” option.

The term “caching” is used herein to denote any of the following functions:

(1) Delivery of information, files or content;

(2) Intelligent delivery based upon files a user has maintained in local storage, thereby enabling constant synchronization of files in nominated directories;

(3) Enabling of rapid local access of cached content, subject to the constraint wherein space is used up and cached content may be archived, discarded or otherwise moved to other storage, preferably on a “least recently used” (LRU) basis; and

(4) If multiple instances of the MySharer embodiment are provided, enabling distributed local storage of information, files or content.

There are three basic kinds of algorithms. Referring to FIG. 6, the ‘push’ algorithm works on a first machine and compares dates and times of origin of files to the dates the last time it looked. It keeps a record of dates and times of files last time it looked and compares to current dates and times and if it finds there is something new it pushes that file to wherever it has been designated to push it, whether it is from a client to the server or to another client.

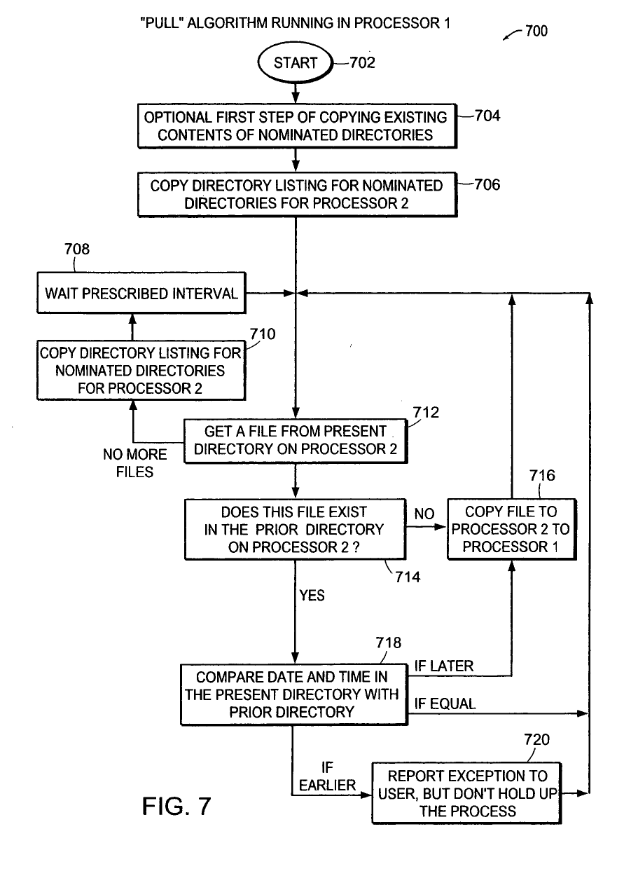

Referring to FIG. 7, there is depicted a “pull” algorithm, machine 1 could check on machine 2 to see the dates and times of origin of all the files, and stores those dates and times either on machine 2 or on its own machine. Then it can next time around compare the dates on the stored version of machine 2 directory with the new dates in its directory and it can see what files are new on machine 2 and pulls those to it, that's a pull and the other first described is a push.

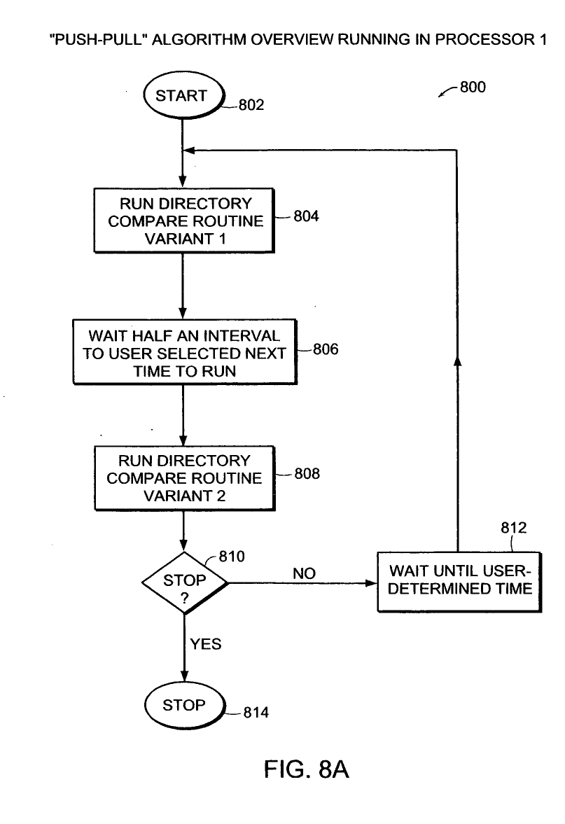

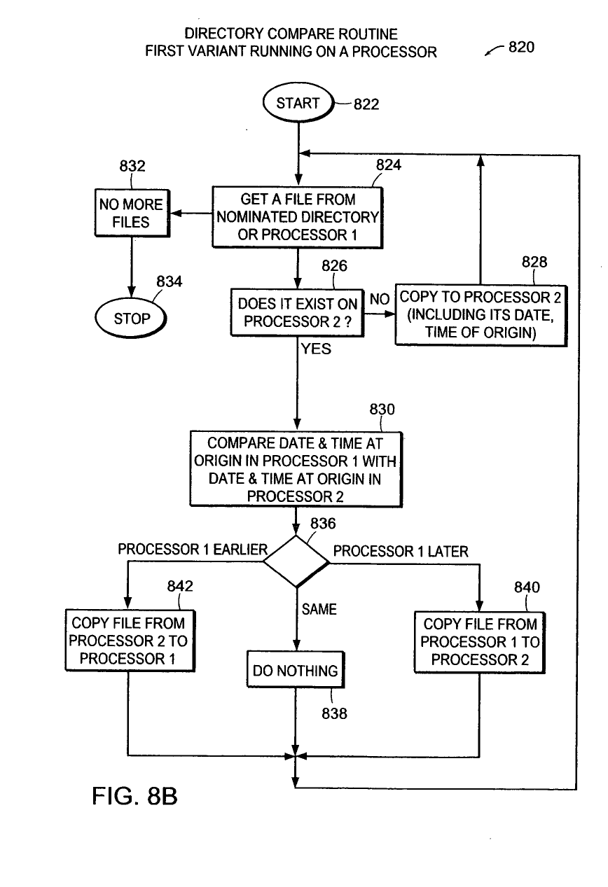

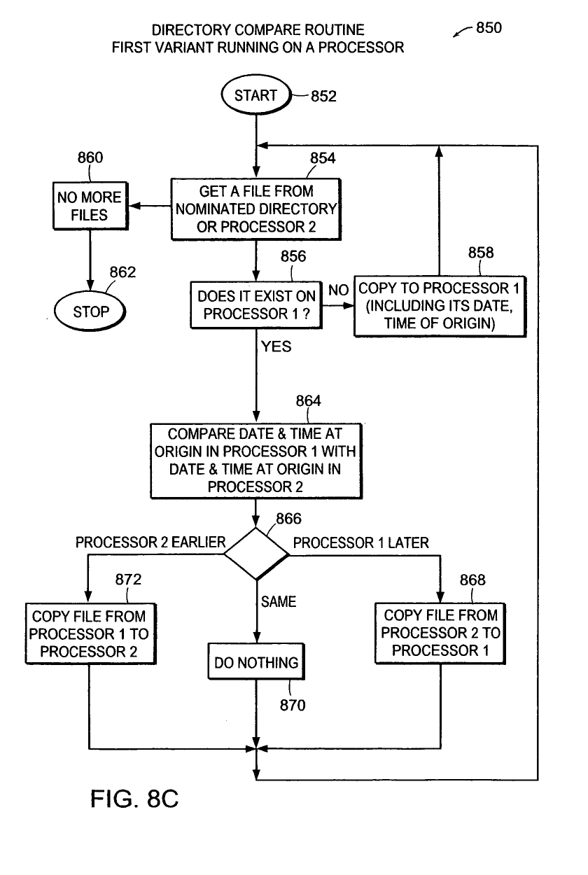

Referring now to FIG. 8a, there is depicted a “push-pull” configuration, wherein the files from machine 1, the present date and time of origin is compared with the present time and date of origin of the files on machine 2 (and the date and time of origin may be normalized to a standard time and date) and wherever the date and time of origin is later, the object is transferred whether by a push or pull. In essence, there is a comparing of two directories and the directories are showing not the time that the file arrived on that machine but the time it was originated on the first machine it was created on. That time is carried forward separately from the time it gets on to machine 2. It is noted that the date and time of origin denotes the date and time of last revision, as opposed to originating revision.

Detail of “Pull” AND “Push-Pull” Algorithms (FIGS. 6,7, and 8a Through 8c).

FIGS. 6,7 and 8a through 8c are flowcharts of the push, pull, and push-pull algorithms respectively, showing specific examples of the more general corresponding figures of FIGS. 1a, 1b, 1c as described earlier.

The MySharer client-based “push” function can be employed for the basic publishing function of MySharer, and for broadcasting, or otherwise delivering content to itself (for archiving), or other PCs, servers, and other communications devices such as faxes, telephones, pagers, televisions or the like. In particular, the local directory (itags) file is one that can be pushed, although this is not required for the “push” function to operate. As seen in FIGS. 6 through 8, although the first step after starting is “Copy Directory From Machine 1”, and all these algorithms are depicted as running in machine 1, the MySharer system runs in association with more than one machine.

At the first step, the directory is copied from machine 1, then to wait for some interval that is defined by parameters and then to get a file from the present directory on machine 1. For example, if the operating system on a client is Microsoft Windows, the invention will allow the files to be read from a directory and say “Get File” until all the files in the directory are exhausted and MySharer has obtained all of them. In this embodiment, after obtaining a listing of directories, there is a ‘wait’ and you get a file from the present directory on machine 1. Then the user asks the directory for a file, which puts the system in a loop and goes around and gets files. Then, a check is made whether this file exists in the prior copy and if it does, the date and time in the present directory is checked to the earlier copy of the prior directory. If it doesn't exist, the file is copied to machine 2, etc. It is a new file since it was last looked and made a directory copy. If it exists, a check is made of the date and time and if the date and time in the present directory is later than on the copy, then you copy the file to machine 2. This is the “push”ing of new files and new revisions of files.

The push algorithm does not need online access to the server or the servers directory to operate, so in some applications, it could send this material by fax or email. In essence, by comparing what is in the directory now to what was in the directory when the last time it was checked, if anything new or updated appears, that can be sent by fax or email. This is a case of a single client to a single directory. There may be multiple clients to a single server directory, in which case a push-pull, two function, two way algorithm is used. In this case, there is an optional first step of copying the existing contents before new data is monitored.

In this context, the directory file stored during the last time MySharer was run is compared to the present directory contents on the present run, and new and revised files are eligible (subject to filtering) to be “pushed” to the server (or to other clients, email, or the like).

A MySharer client-based “pull” function would be used to keep a client current with new materials added by other networked users that arrive at a server. In particular, each instance of MySharer running on a client PC would “pull” new files or newly-modified files from the server.

In a client-based pull configuration the server directory is stored on a file on the server and/or client after every MySharer run. On the next run, the stored server directory is compared to the directory as it exists currently, and new and revised files are eligible for “pulling” to the client (including the stored directory, which can thereby be cached locally).

It is contemplated that the server-based “pull” function can utilize any conventional transport protocol to obtain access to the client, and would compare the most recent copy of the client directory against the present client directory, to indicate which files are eligible to be “pulled” to the server from the client.

The server-based “push” function also can utilize any conventional transfer protocol on the client, and would compare the most recent copy of the server directory against the present copy of the server directory, and would then “push” new material to clients or a list of clients, or to email, other servers or the like.

It is also contemplated that both “push” and “pull” on the server would utilize the MySharer architecture described running on the server, and both functions (“push” and “pull”) could operate as different processes on the same or different directories.

The “push-pull” algorithm would compare the present directory on one PC (or similar processing system) to the present directory on one or more other machines, and in response to that comparison, move recent files in either direction (from PC ‘A’ to PC ‘B’, or vice versa) that are eligible for transfer. This algorithm also can run on the client or on the server, and target either clients or servers.

The push-pull algorithm provides efficient transfer and coordination between multiple servers, between servers and clients, and between client peers.

The “push” and “pull” algorithms running simultaneously on the client would be useful when more than simple “mirroring” of updated files is required. By way of example, if a user wishes to “push” to a server from one directory or client, while maintaining a “pull” to another directory, simultaneous “pull” and “push” functions could be maintained.

Similarly, server-based “push” and “pull” algorithms would be advantageous for clients unable to run the client-based MySharer architecture as described herein.

It is to be noted that any of these algorithms may operate singly or in combination with the other algorithms, in a client or a server, or both.

FIG. 8b shows a directory compare routine showing a first variant on a first processor or machine 1. After getting a file from a nominated directory on machine 1 and checks to see whether it exists on machine 2. If machine 2 does not have this file, the file is copied to machine 2 including its date and time of origin. This routine is performed until there are no more files and the system stops. If however, the copy does exist on machine 2, the date and time at origin in machine 1 is compared with the date and time at origin in machine 2. If machine 1 is later than machine 2, copy the file from machine 1 to machine 2. If machine 1 is earlier than machine 2, the algorithm copies the file from machine 2 to machine 1. If the date and time at origin on both machines is the same, the system does nothing. This routine is invoked periodically alternating with a variation that gets the directory from the machine.

FIG. 8c shows a directory compare routine showing a second variant on a first processor or machine. After getting a file from a nominated directory on machine 2, the system checks if this file exists on machine 1. If it does not exist, the file is copied to machine 1 including the date and time at origin. This query and copy continues until there are no more files. If however, the copy does exist on machine 1, the data and time at origin is compared in machine 1 with date and time at origin in machine 2. If the date and time of file in machine 1 is earlier, the file is copied from machine 2 to machine 1. If the date and time of file in machine 2 is earlier, the file is copied from machine 1 to machine 2. If the date and file on machine 1 and machine 2 are the same, the system does nothing.

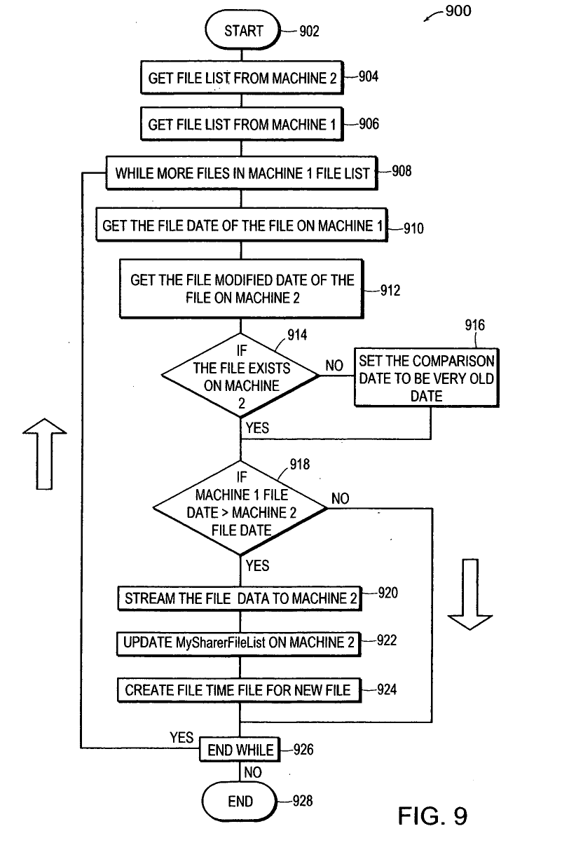

Examples of Implementation of MySharer (FIGS. 9,10,11,12)

Overview As a further example of the application of the invention, The MySharer client based pull can be used for keeping a client current with contributions from others arriving on a server (in the case of an FTP server the only way). In a client based pull, the server directory can be stored on a file on the server after every MySharer run. On the next run, the stored server directory is compared to the directory as it exists at that time and new and revised files are eligible for pushing (including the stored directory which can thereby be cached locally).

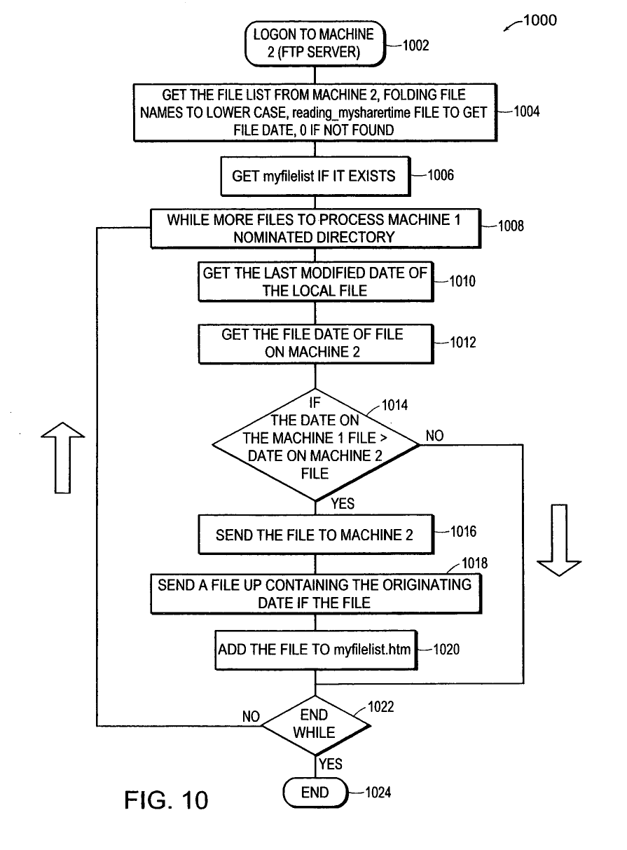

FIG. 10 is an example of PC to Web Publishing using the FTP server. The MySharer client based push is used for the basic publishing action of MySharer. The local directory (itags) file is one that can be pushed, though this is not required for the push operation to work. The directory file stored that last time MySharer was run is compared to the present directory contents on this run and new and revised files are eligible (subject to filtering) to be pushed to the server (or other clients or email etc). A server based pull would need FTP access on the client and would use the last copy of the client directory against the present client directory, to indicate which files are eligible to be pulled to the server from the client.

A server based push would use the FTP on the client also, and would compare the last copy of the server directory against the present copy of the server directory to push new material to a list of client or email or other, servers etc. Both push and pull on the server require MySharer to run on the server, and theoretically, both could operate as different processes on the same or different directories. The push-pull algorithm compares the present directory on one machine to the present directory on one or more other machines and move recent files in either direction when they are eligible for transfer. This algorithm too can run on the client or on the server, and target either clients or servers. There are several advantages for each type of these algorithms. The push-pull algorithm is advantageous for the efficient transfer between multiple servers, between servers and clients and between client peers. The push and pull algorithms running on the client are useful when there is more structure than simple mirroring; e.g. if the user wishes to push to a server from one directory or my client and pull to another directory. The server based push and pull algorithms may be useful for clients unable to run the MySharer system themselves.

Any of a number of transport protocols operating over a communications channel could be utilized, such as FTP, HTTP or the like, to enable the “push”, “pull” and “push-pull operations”.

Figures

FIG. 9 is a flowchart describing the PC to Web Publishing implementation of the MySharer using the IBOOK server as a preferred embodiment. In this example, the system gets the files lists from machine (or processor) 2 and machine 1. If there are more files in Machine 1 list, it gets the last modified date of the file on machine 1, and gets the last modified date of the file on machine 2. If the file does not exist on machine 2 the comparison date is set to be the very old date. If the machine 1 file date is greater than machine 2 file date, the file data is streamed to machine 2 and the MySharer file list on machine 2 is updated, and a time file is created for the new file. This process continues as long as there are more files in machine 1 file list or if the machine 1 file date is not greater than machine 2 file date.

FIG. 10 shows another embodiment in which the FTP method describing a PC to Web Publishing using the widely available FTP server. At step, there is a logon to machine 2 (FTP server). The file list from machine 2 is generated. The filenames are folded to lower case, the MySharer time file is read to obtain the file date. If not found, gives a zero. If the Getmyfilelist exists, while more files to process Machine 1 in the nominated directory, the last modified date of the local file is obtained, and gets the file date of file on machine 2. The system queries if the date on the machine 1 file is greater than the date on machine 2. If it is not, it repeats this until more files are processed, or goes to the end. If the date is greater, the file is sent to machine 2, and a file is sent containing the originating date of the file. This file is added to myfilelist.htm (at step 18).

Although both the embodiments in FIGS. 9 and 10 show the use of client time comparisons, these algorithms will also work if client last modified time is compared to server last modified time.

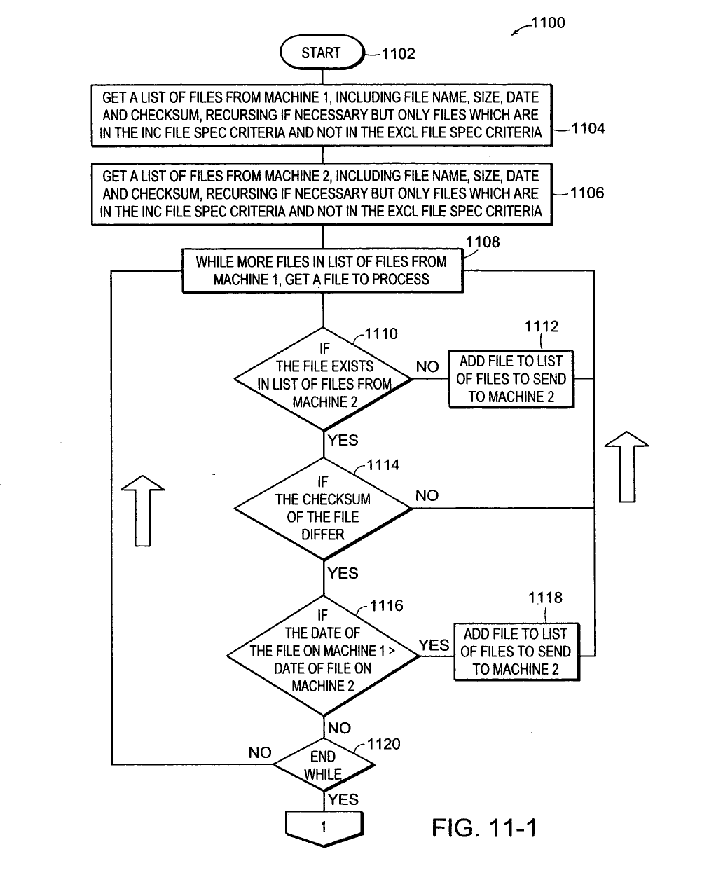

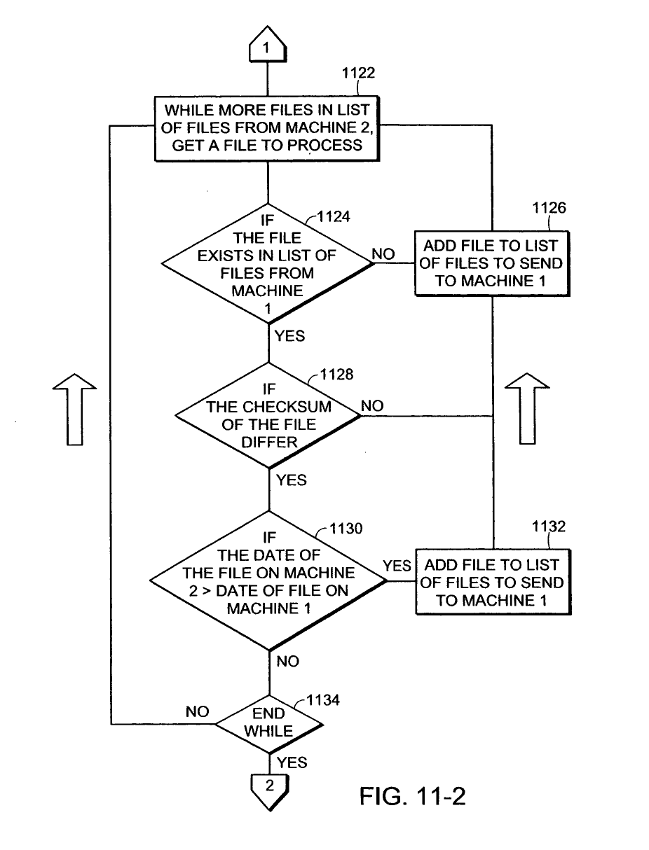

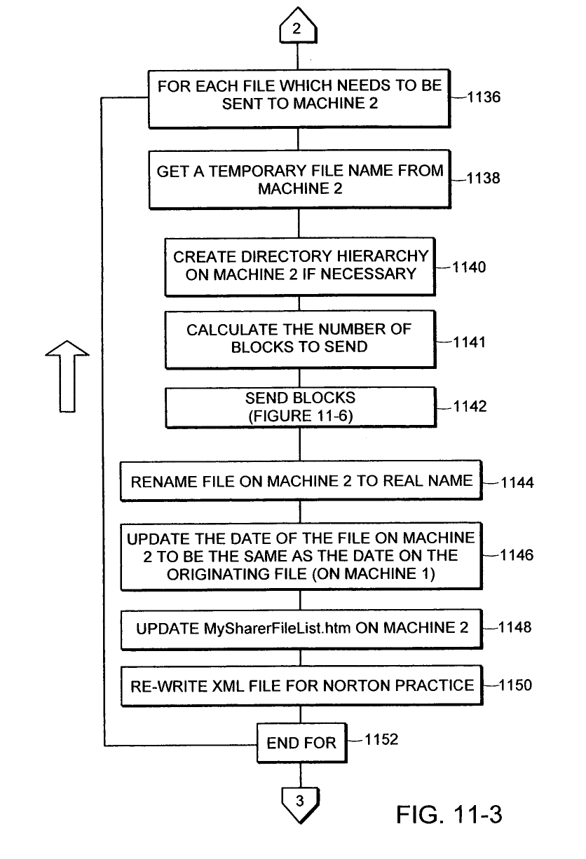

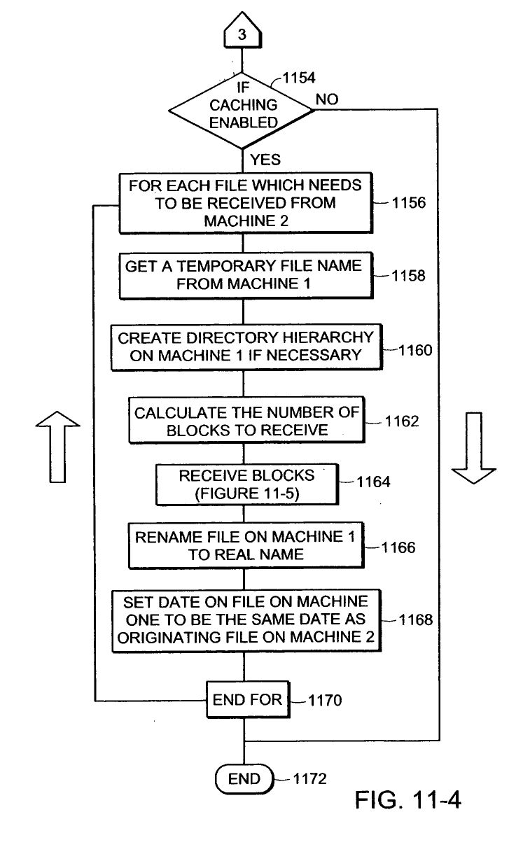

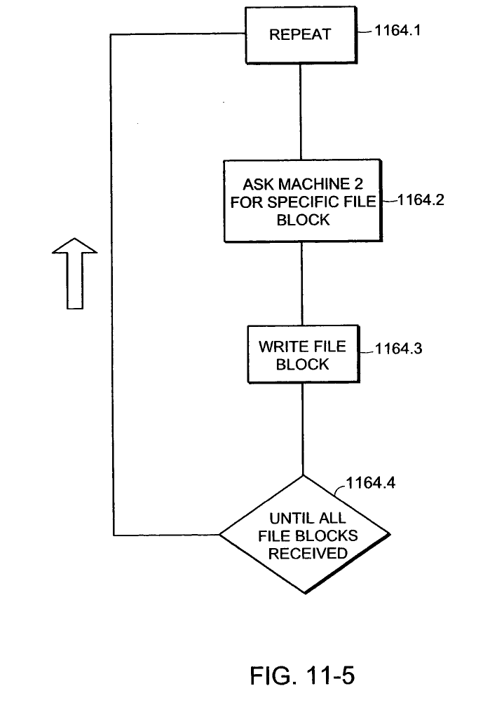

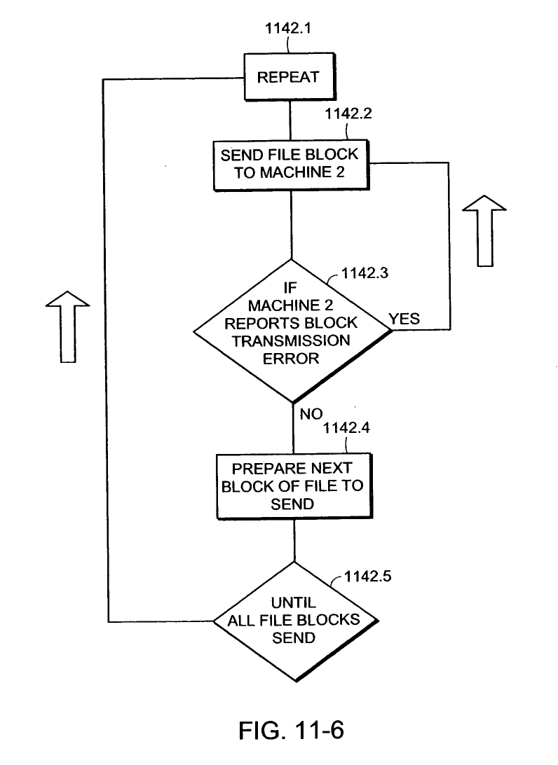

FIG. 11 (pages 11-2 through 11-6) shows the example of a PC to Web Publishing and Caching using an IBOOK server as a preferred embodiment.

FIGS. 12a through 12h refer to Steps 1 through 8, which are screen shots generated by the method and system of the invention.

Step 1 (FIG. 12a) depicts the “MySharer” main window, which permits the user to see the status of files in his or her nominated directories being published and/or cached from a web server. The window also permits the user to start and stop the MySharer daemon.

Thus, as shown in Step 1, the user is presented with Start and Stop buttons, and information such as the following:

“Welcome to MySharer. MySharer is an exciting new way to publish your files to the web. It allows you to work normally with all your existing applications, but have your files published to the web on your behalf.”

Step 2 (FIG. 12b) is the MySharer configuration window, which permits the user to specify one or more nominated directories, along with their related mapped URL. In the example, shown, the nominated directory is c:\ibook\sharetest\word. The related URL (to which files in the nominated directory can be mapped) is

http://www.eternalguestions.com/sharetest2. As shown in the window, the following mapping is created thereby:

C:\ibook\sharetest\word->http://www.eternalquestions.com/sharetest2

Step3 (FIG. 6c) shows MySharer in operation after the Start button has been pressed. As indicated, the system is shown checking the nominated directories. The following information is provided:

“MySharer Daemon Started.

Checking Nominated Directories

Checking Dir: c:\ibook\sharetest\word.mapped URL:

http://www.eternalquestions.com/sharetest2

Finished Checking Nominated Directories

Step 4 (FIG. 12d) shows an example of a Windows application being employed, in this case, Microsoft Word. As shown therein the upper sub-window is the MySharer main window. The lower sub-window is the Word document: “Here I am editing a Word Document. I'm using my windows applications the same way as I've always done. MySharer will take care of my publishing. Business as usual.”

Step 5 (FIG. 12e) shows the Word document being saved. As shown therein, Word opens the Save As window, and the user will save a Word Document named MyWordDocTest.

Step 6 (FIG. 12f) shows MySharer recognizing that there is an updated file (MyWordDocTest.doc) in one of its nominated directories. The main window shows that it has been recognized and sent to the web server, as follows:

Checking Dir c:\ibook\sharetest\word.mapped URL:

http//www.eternalquestions.com/sharetest2

Finished Checking Nominated Directories.

Checking Nominated Directories.

Checking Dir: c:\ibbok\sharetest\word.mapped URL:

http://www.eternalquestions.com/sharetest2

MyWordDocTest.doc: File Startupload:success

Finished Checking Nominated Directories

Step 7 (FIG. 12g) shows MyFileList.htm on the server, and the designation of MyWordDocTest.doc.

Step 8 (FIG. 12h) shows the result of the MySharer operations. This screen shot clearly shows that the document has been published to the web (as shown in Step 8, the Address bar displays the following URL: http://www.eternalquestions.com/sharetest2/MyWordDocTest.doc), and users can browse it in their browsers, in one embodiment of the invention. As noted elsewhere herein, in another embodiment of the invention, the web server can distributed the file to one or more other users, automatically or on demand.

Other Examples—Timestamp Generation

There are many ways to use timestamps in the present invention. For example, timestamps can be generated not only upon creation and revision of data objects but also whenever a selected event occurs. That selected event might occur, for example, when the user clicks on a “Save” button to save a file or other data object. At that point the content can be stored either on the client (if employing native PC applications) or a server (if in an ibook embodiment) as shown in FIG. 5.

In another example, servers holding material not originated on them can act as a cache memory for the another machine's content. The date, and timestamps created on content creation or revision are part of the content and should not be changed by the system. In the example of multiple replicated servers or various levels of caching, it may be useful to normalize to a selected time zone, such as GMT, EST, etc. using an internet time server. Each machine's originating content (client e.g. DOC or server e.g. HTML) periodically creates a difference to GMT internet reference time so that when content from different machines is being collected, each revision can be sorted by its date and time of origin expressed in internet reference time. For comparisons of date and time stamps between revisions originating on different machines, the Internet reference times of each can be compared.

For comparison of date and time stamps of revisions arising on the same machine, it is not necessary to convert to an internet reference time but may be advantageous to deal with situations arising if the clock is reset or adjusted. When this occurs, non-adjusted times could be duplicated or reverse ordered in different revisions. To overcome this, internet reference times could be used, but a new check would need to be made frequently, example, on every comparison, and the internet time at the time of detection would be stored in the file or associated meta file or directory. Then push or pull comparisons would be impervious to clock changes. Alternatively, if all that time checking is too burdensome, its new internet time difference could be recorded whenever the clock is reset and periodically, with sufficient frequency to catch any significant wandering over time of the PC clock from internet time.

Self Replicating Websites

In another embodiment, the MySharer system provides a self replicating website, wherein an existing template is copied and populated with available directory files and directories. The system can use the MySharer further described above to duplicate the features and structures of a given website. In one embodiment of this aspect, the system creates a template of one or more existing templates representing website structures such as directories, and then populate them using existing PC tools. Such a self replicating website could be envisioned working with or without an IBOOK configuration.

User Interfaces

The invention can utilize a conventional user interface (UI) to permit the user to specify nominated directories. This is the list of directories (e.g., a user's default Word directory) that the invention will examine or periodically or continuously monitor to determine which new or updated files are to be published to the Web or remote server. In addition, the user can specify a relationship to a remote Web directory, i.e., a mapping between a local cache directory and Web directory (or ibook directory in an ibook-based implementation).

New Files Created on Client

The system of the invention can examine its nominated directories and check periodically for any new files. In particular, the system can check for any files with a timestamp greater than the date/time last checked. If a new file is found it can be copied or sent to the designated Web server location for this directory.

New files Created on Server

The client portion of the system can periodically query the server to determine whether any new files have appeared on the server in the nominated directory. The system and method utilizes the following functions to track file data and time changes. The server is asked to list all files that are new, since the last new file download. Each of these new files is then downloaded. The date and time of this file is kept track of, as this will be used to ask the server about new files in the next iteration.

Updated Files on Client and Server

The invention can periodically check the LastModifiedDate of all files in its nominated directories, and compare those dates with the LastModifiedDate of the related files on the web server, and arrive at the following results. If client file date is greater than the server file date, the client file is uploaded to the server. If client file date is smaller than the server file date, the file is downloaded from the server.

Transfer Protocol

The invention can utilize any or all of a number of implementations for transferring back and forth between cache and server, including, e.g., FTP, HTTP. The invention can also utilize the ibook revisioning mechanism described in Appendix A (the ibook patent).

Configuration

The MySharer daemon can utilize a set of functional features provided as options that could be set by the user. By way of example, this function can be handled in the configuration panel of the ibook controller. The options can include the following features. The “Include Revisions”s option will include the caching of all ibook revisions of a file from the server to nominated directory. The “No Caching” feature, when selected, instigates the Daemon to act purely as an autonomous web publishing agent. The updated files on the server will not be cached to nominated directories. The “Single Dir mapping” will provide all to be mapped into the same single directory of the nominated local cache. The “Multi Dir” option will provide mapping of sub directories that will be created for every contributor contributing to the nominated server directory, and their file (directory), and their files cached to their directory. The “Include sub-dir” option when selected, enables the MySharer Daemon to include all sub-dirs of a nominated local directory in terms of checking for new or updated files.

Typical Instructions for Download of Client Portion:

The following are typical instructions that might be provided to a user of the system “MySharer”, in accordance with one embodiment of the invention.

Download MySharer:

This is version X.XX of MySharer This version will publish new and updated files from a nominated local drive to the web, and can also cache files. MySharer will also create a file called myfilelist.htm in your mapped server directory, which will list all the files you have added. As presently configured, updated files will also appear on the end of the list, regardless of whether they were on the list before.

Directions:

Download and zip into a directory

To Run, type “jview MySharer”

When started click on Options, set:

Nominated Dir is the local directory you want to publish from (must exist) e.g. c:\myfiles

The full URL (including http://) of the destination server directory (must exist) e.g. (see note 3)

As currently configured, MySharer is set up to check approximately every 30 seconds (you will see “checking” and “Finished checking” displayed every iteration)

Click on Start to Start the Daemon

Click on Stop to stop it

MySharer Functions Expressed in Verbol Language

In another embodiment of the invention, the method described herein can be implemented in a language referred to as Verbol, which utilizes, inter alia, expressions of the form WHENEVER {condition}, {action}. Thus, for example, the operations depicted in FIGS. 2, 3 and 4 can be expressed as Verbol statements, and the actions can be applied across all designated directories and files. It will be understood that such Verbol states can express such conditions as what type of caching has been selected (e.g., single directory, multiple directory). Verbol statements capable of expressing the operations depicted in FIGS. 2, 3 and 4 can take the following forms:

Whenever new file in nominated directory, copy [as new revision] to related server ibook.

Whenever new file in server ibook, cache file [in related nominated directory].

Whenever server file timestamp greater than cache file timestamp, cache file.

Whenever cache file timestamp greater than server file timestamp, copy file to related server ibook.

Although the previous example shows Verbol language, those skilled in the art will recognize that the above function can also be expressed in other similar languages. In yet another embodiment of the system and method, there is provided a “My-Emailer” system that could take files from a specific directory and send them to an email list for distribution via email messages.

Interactive Web Book

In another practice of the invention, the system “MySharer” can be used with an interactive web book (I-book). Here, enrollees to a MySharer web site, whether or not they have installed a MySharer client software package (as described herein) can access all the shared material on that site from a standard browser, wherein “access” includes viewing and modifying using ibook objects, as permissions are granted by either MySharer sponsors for site-wide material, or by MySharer client users who control access to their identity ibooks.

In an ibook-based embodiment of the invention, an important advantage of the MySharer daemon running in the ibook controller of the client is that substantially all significant operations are under the user's control. The user can specify what he wants downloaded to or uploaded from his machine(s) by changing the “whenever [new][changed etc.] file” statements in the vspace of the user's identity ibook.

Also, in this embodiment, it is expected that to create one's own MySharer application, a user could enroll, for example, in ibook.com to obtain the ibook server and ibook controllers (see, e.g., the ibook patent incorporated herein by reference), and utilize a variant of MySharer itself to copy and customize a template ibook application, which will become one's own MySharer application.

In addition, a single user could have multiple instances of MySharer, such as a personal MySharer, family MySharer, group, community, and public MySharer, for any kind of private or public purpose in the realm of redistributing information. Accordingly, a MySharer application can be viewed as an “information-redistributing web robot” as described in the ibook patent attached hereto as Appendix A.

Similarly, MySharer can be used to create template Ibook applications from an existing application, and when selected, MySharer would function as an application construction wizard, inviting the user to select or install a server, identity and subject ibooks, enrollment rules, and the like. Accessing MySharer directly on ibook.com could allow the user to initiate a MySharer application in a similar fashion, again listing existing MySharer web sites in which to enroll and inviting construction of one's own.

The invention thus allows users to, among other things, to seamlessly share music, text, pictures, faxes, email, phone calls, video, animation and other content among a group of community, or with the public, and to access the shared material from any computer, using only a browser and a communications channel.

The foregoing is merely illustrative of the principles of this invention, and various modifications can be made by those skilled in the art without departing from the scope and spirit of the invention. In particular, those skilled in the art will appreciate that the methods, systems and devices described herein can include devices, systems and software other than Microsoft-based PCs and servers, or networks other than those described herein, and thus the examples set forth herein are provided only by way of illustration and not by limitation.

1. A system for use by at least first and second processors linked by a communications network, for enabling the first processor, in accordance with a selected event to automatically send a copy of at least a first designated local data object from the first processor to the second processor, the system comprising:
means for designating on said first processor, at least a local data object for automatically updating to said second processor via the communications network;
means for initially sending a representation of said local data object from the first processor to the second processor via the communications network; and
means for initially creating a remote data object in response to the event.

2. The system as in claim 1 wherein the selected event may be triggered by any of:
a particular time or times;
at predetermined time interval;
any most recent change;
whenever a new file is detected;
whenever an object is updated;
whenever a directory is changed.

3. A system as in claims 1 and 2 wherein said first processor in accordance with said selected event can create a copy of a first local data object on the first processor under a different name, preferably incorporating a date and time stamp, and further capable of distributing said data object automatically or on demand.

4. A system as in claims 1-2 wherein the selected event triggers copying a new file or copying a revised data object.

5. A system as in claim 1, further comprising means, on the second processor, for updating the remote data object on the second processor using the information representative of the change.

6. A system as in claim 1-2, 4-5, further comprising means, on the first processor, for updating the remote data object on the second processor.

7. A system as in claim 1, wherein the remote data object can be created on the second processor.

8. A system as in claim 1, wherein the second processor includes means for initially creating a remote data object in response to an event.

9. A system as in claims 1-2, 4-8 further comprising:
means for copying the updated remote data object from the other processor to the querying processor;
means to enable any processor in the group to query any other processor to determine whether the other processor has an updated remote data object in a nominated directory.

10. The system of claims 1-9 wherein
any processor in a group of processors can copy the updated remote data object from one processor to another; and
any processor in the group can query any other processor to determine whether the other processor has an updated remote data object in a nominated directory.

11. The system of claim 1-10 wherein the second processor is a server computer.

12. The system of claim 1 wherein the second processor is a client.

13. The system of claim 1-2, 4-11 wherein the first processor is a client computer.

14. The system of claim 1 wherein the first processor is a server.

15. The system of claims 1-2, 4-14 wherein the new remote data object is published on a website at the server.

16. The system of claim 15 wherein a user on the first or third processor can view the new remote data object on the server computer using a browser.

17. The system of claim 15 further comprising means for automatically distributing a representation of the new remote data object from the server computer to the third processor.

18. The system of claim 10 further comprising means for distributing the updated remote data object to the third processor upon demand by the third processor.

19. The system of claim 18 wherein the remote data object is distributed to any processor automatically whenever there is a new or updated data object on any of other processors.

20. The system of claim 1 wherein a data object is a data file.

21. The system as in claim 1 wherein the data object is a program file.

22. The system as in claim 1 wherein the data object is any information file.

23. The system as in claim 1 wherein the data object is an executable file.

24. The system as in claim 1 wherein the data object is a PC document.

25. The system of claim 1 wherein a data object can further comprise any of a file or a directory, and wherein a directory can further comprises at least one other directory.

26. The system of claim 20 wherein the data file contains multi-media information.

27. The system of claim 26 wherein the data file is a Web based document.

28. The system of claim 26 wherein the data file is a client based document.

29. The system of claim 26 wherein the data file is in an html format.

30. The system of claim 26 wherein the data file is in PC format.

31. The system of claim 20 wherein the means for automatically sending information representative of a change further comprises:
means for detecting the occurrence of a change to a designated local data file;
means for determining information representative of the change made to the designated local data file; and
means for sending the information representative of the change to the designated local data file from the first processor to the second processor, via the communications network.

32. The system of claim 31 wherein the means for detecting the occurrence of a change further comprises:
means for assigning a timestamp to a data file when the data file changes;
means for storing a time of last change in the first processor;
means for comparing the data file timestamp of each designated file with the stored time of last change to determine whether the data file has changed.

33. The system of claim 1 wherein a data object is a directory containing at least one object, said directory further comprising directories or files.

34. The system of claim 13 wherein the means for detecting a change further comprises means for generating a new timestamp upon the occurrence of a selected event.

35. The system of claim 34 wherein the means for generating a new timestamp includes means for generating a new timestamp when a data object within the directory changes.

36. The system of claim 35 wherein the means for generating a new timestamp includes:
means for generating a new timestamp when a new data object is added to a nominated directory.

37. A method for use by at least first and second processors linked by a communications network, for enabling the first processor, in accordance with a selected event to automatically send a copy of at least a first designated local data object from the first processor to the second processor, the system comprising:
designating on said first processor, at least a local data object for automatically updating to said second processor via the communications network;
initially sending a representation of said local data object from the first processor to the second processor via the communications network; and
initially creating a remote data object in response to the event.
